(19) United States
(12) Patent Application Publication
(10) Pub. No.: US 2011/0020763 A1
(43) Pub. Date: Jan. 27, 2011

(54) Endodontic Applications of Tissue Liquefaction

(76) Inventors: Mark S. ANDREW, Haddonfield, NJ (US); Luis A. Davila, Alpharetta, GA (US)

Correspondence Address: PROSKAUER ROSE LLP, One International Place, Boston, MA, 02110, US

(21) Appl. No.: 12/841,348

(22) Filed: Jul. 22, 2010

Related U.S. Application Data
(60) Provisional application No. 61/228,021, filed on Jul. 23, 2009.

(51) Int. Cl. A61C 5/02; A61C 3/00

(52) U.S. Cl. 433/32; 433/81; 433/96; 433/224

(57) ABSTRACT

During root canal procedures, pulp may be removed from a tooth without disturbing the dentin by directing pulses of a heated liquid onto the pulp at particular temperatures and pressures to liquefy or gellify the pulp. The liquefied or gellified material is then aspirated away using the methods and apparatuses described herein. In some embodiments the heated liquid also functions to kill bacteria that may be present within the tooth.

### CROSS REFERENCE TO RELATED APPLICATIONS

This application claims the benefit of U.S. Provisional Application 61/228,021, filed Jul. 23, 2009, which is incorporated herein by reference.

### BACKGROUND

The devices and methods described herein expand on the teachings of U.S. Pat. No. 6,676,629, entitled Tissue Liquefaction and Aspiration for Dental Treatment, which is incorporated herein by reference.

A conventional endodontic therapy (root canal) procedure includes three steps: In the first step, an opening is made in the crown of the tooth, which allows access to the root canal system. It is important to have a large enough opening to find all the canals inside a tooth. Anatomy inside the tooth is variable. Some teeth have just one canal like most upper front teeth. Premolars have 1 or 2 usually. Molars or the back teeth typically have 3 or 4.

In the second step, the pulp is removed from the pulp chamber and root canals. Tiny instruments are used to clean the root canals and to shape them to a form that will be easy to fill. Irritants are used to dissolve and flush debris. If this step is not completed in one visit, medication will be placed in the canals and a temporary will be placed in the opening to protect the tooth between visits. Radiographs (X-rays) are taken periodically during the cleaning process to check if the instruments are cleaning near the end of the root. The end result of this step is a thoroughly cleaned out root canal

In the third step, the cleaned-out root canals are filled with a rubber like compound called gutta percha. A cement is also used to help seal the canals to prevent bacteria from reentering. In many cases, the opening in the crown of the tooth is sealed with a temporary filling. At some later time, the access opening in the crown is filled with a build up restoration. Occasionally, enough tooth structure is missing to warrant use of a post to help retain the final restoration. After endodontic treatment, radiographs (X-rays) are taken to verify that cleaning and filling of the canals is close to the end of the root.

Endodontic files are instruments that are conventionally used in the debridement of root canals, for the second step described above. They are usually made of either stainless steel or nickel titanium and come in different sizes. They are used with mechanical rotation systems or by hand to remove the pulp from the root canal, and the removal of the pulp is based on mechanical abrasion techniques. Conventional files, however, remove both target (pulp) and non-target (dentin) tissues, and the process actually enlarges the root canal when dentin is removed.

One disadvantage of using conventional files is that the files occasionally break when they are deep in the canal. When this happens, it can be difficult and sometimes impossible to remove the broken piece of the file. Another disadvantage of the conventional mechanical abrasion methods is that they do remove bacteria, and require an additional step to clean the canal prior to sealing.

### BRIEF SUMMARY OF THE INVENTION

After an opening has been made in a tooth, pulp can be removed from that tooth by delivering pulses of heated fluid under pressure, via a first conduit, so that the fluid exits the conduit and impinges against the pulp. The heated, pressurized pulses of fluid soften, liquefy, or gellify the pulp. The fluid and the pulp that has been softened, liquefied, or gellified is then suctioned away, via a second conduit. This process is preferably repeated until substantially all the pulp has been removed from the tooth.

### BRIEF DESCRIPTION OF THE DRAWINGS

FIG. 1 is a block diagram of a system for removing pulp from teeth during root canal procedures.

FIG. 2 depicts a number of suitable shapes for the distal end of instruments used to remove pulp from teeth.

FIG. 3 is a detail of the distal portion of an instrument for removing pulp from teeth that implements both liquefaction and aspiration.

FIGS. 4A, 4B, and 4C are details, in three different positions, of the distal portion of another instrument for removing pulp from teeth that implements both liquefaction and aspiration.

### DETAILED DESCRIPTION OF THE PREFERRED EMBODIMENTS

The Phaser is used to replaces step 2 of the conventional mechanical method described above, and provides an improved method that removes only the target tissue (pulp), while not impacting the non-target tissue (dentin). In addition to target tissue removal, the Phaser system also has the capability of removing or killing bacteria without using irritants. The Phaser operates by using a handheld instrument to shoot a series of pulses of heated biocompatible fluid onto the targeted tissue, which softens, gellifies, or liquefies the target tissue. After the tissue has been softened, gellified, or liquefied, it is suctioned away out of the tooth.

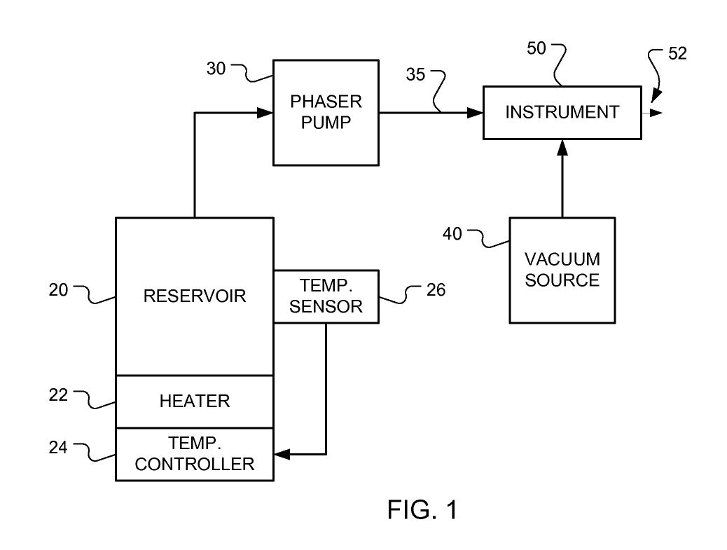

FIG. 1 depicts one suitable system for endodontic applications uses a fluid supply reservoir 20, a heater 22 that heats the fluid in the reservoir 20, and a temperature controller 24 that controls the heater 22 as required to maintain the desired temperature, based on signals received from a temperature sensor 26. Pump 30 pumps the heated fluid from the reservoir 20 down the fluid supply tubes 35 and through the instrument. Preferably, the pump delivers a pressurized, pulsating output of heated fluid down the supply tube 35 so that a series of boluses of fluid are ejected from the delivery orifice 52 at the tip of the instrument 50.

Temperature control may be implemented using any conventional technique, which will be readily apparent to persons skilled in the relevant arts, such as using a thermostat, thermistor, or a temperature-sensing integrated circuit as the sensor 26. The temperature may be set to a desired level by any suitable user interface, such as a dial or a digital control, the design of which will also be apparent to persons skilled in the relevant arts.

The heated fluid may comprise a sterile physiological serum, saline solution, glucose solution, water, or another biocompatible fluid.

The pump 30 may be a piston-type pump that draws heated fluid from the reservoir 20 into the pump chamber when the pump plunger travels in a backstroke. The fluid inlet to the pump has an in-line one-way check valve that allows fluid to be suctioned into the pump chamber, but will not allow fluid to flow out. Once the pump plunger backstroke is completed, the forward travel of the plunger starts to pressurize the fluid in the pump chamber. The pressure increase causes the one-way check valve at the inlet of the pump 30 to shut preventing flow from going out the pump inlet. As the pump plunger continues its forward travel the fluid in the pump chamber increases in pressure. Once the pressure reaches the preset pressure on the pump discharge pressure regulator the discharge valve opens. This creates a bolus of pressurized heated fluid that travels from the pump 30 through the supply tube 35 and through the instrument 50. After the pump plunger has completed its forward travel the fluid pressure decreases and the discharge valve shuts. These steps are then repeated to generate a series of boluses. Suitable repetition rates (i.e., pulse rates) are discussed below.

One example of a suitable approach for implementing the positive displacement pump is to use an off-set cam on the pump motor that causes the pump shaft to travel in a linear motion. The pump shaft is loaded with an internal spring that maintains constant tension against the off-set cam. When the pump shaft travels backwards towards the off-set cam it creates a vacuum in the pump chamber and suctions heated saline from the heated fluid reservoir. A one-way check valve is located at the inlet port to the pump chamber, which allows fluid to flow into the chamber on the backstroke and shuts once the fluid is pressurized on the forward stroke.

Once the heated fluid has filled the pump chamber at the end of the pump shaft backwards travel, the off-set portion of the cam will start to push the pump shaft forward. The heated fluid is pressurized to a preset pressure (e.g. 1100 psi) in the pump chamber, which causes the valve on the discharge port to open, discharging the pressurized contents of the pump chamber to fluid supply tubes 35. Once the pump plunger completes its full stroke based on the off-set of the cam, the pressure in the pump chamber decreases and the discharge valve closes. As the cam continues to turn the process is repeated.

The pump shaft can be made with a cut relief, which will allow the user to vary the boluses size. The cut off on the shaft will allow for all the fluid in the pumping chamber to be ported through the discharge path to the supply tubes or a portion of the pressurized fluid to be ported back to the reservoir. In preferred embodiments, the rise rate (i.e., the speed with which the fluid is brought to the desired pressure) is about 1 millisecond or faster. This may be accomplished by using a standard relief valve that opens once the pressure in the pump chamber reaches the set point (e.g., 1100 psi).

In some preferred embodiments for removing dental pulp, the temperature of the solution is between 80 and 250° F., and more preferably between 140 and 200° F. The fluid is delivered in pulses at a stream pressure between 1000 and 3000 psi at a pulse rate between 10 and 60 pulses per second, and with a duty cycle between about 30 and 80%. This combination of parameters provides good tissue differentiation, so as to facilitate removal of the pulp without removing or harming the dentin.

In one preferred embodiment for removing dental pulp, the temperature of the solution is between 160 and 200° F., and it is delivered in pulses at a stream pressure between 300 and 1300 psi at a pulse rate between 20 and 40 pulses per second. In an alternative preferred embodiment, the temperature is initially lower when the pulp is being removed, and it is raised at the end of the procedure to above 140° F. or to above 160° F. for enough time to kill harmful microorganisms that may be present within the tooth. In other preferred embodiments, the stream pressure is between 300 and 3000 psi.

The aspiration (vacuum) is preferably between 300 and 760 mm Hg, and more preferably between 600 and 760 mm Hg. A conventional vacuum pump (e.g., the AP-III HK Aspiration Pump from HK surgical) may be used for the vacuum source 40. Conventional vacuum sources that are already in use in dentists' offices may also be used.

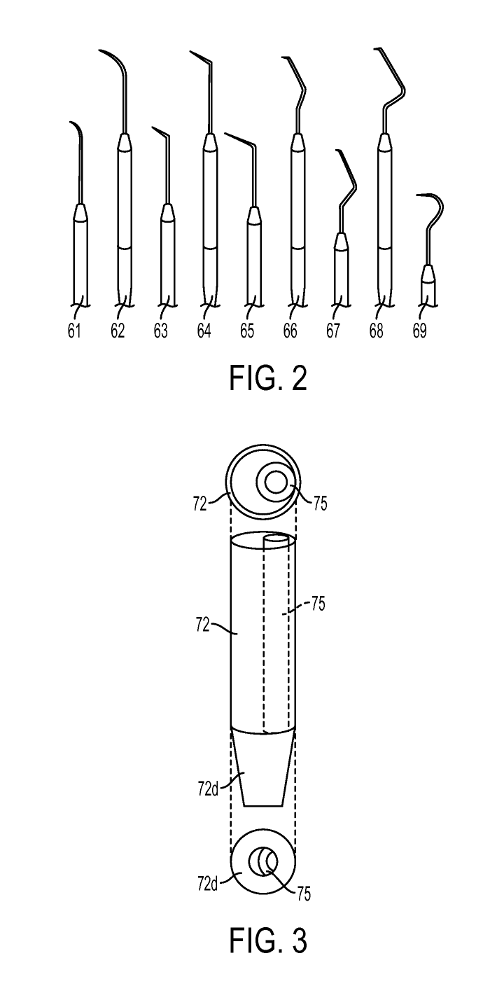

The shape of the instrument 50 can be similar to other dental instruments, where there is some degree of angulation) (0-130° between the tubing attached to the handle and the distal end of the tip. The angulation can be a soft gentle curve or an acute angle. FIG. 2 depicts nine examples 61-69 of shapes that may be used for the distal end of the instrument. Those shapes are based on the shapes of existing dental explores, although alternative shapes may also be used. Of the shapes depicted in FIG. 2, shapes 62 and 69 are preferred.

Several different arrangements may be used for the internal construction of the tip on the Phaser System to achieve tissue liquefaction and removal. In a first embodiment, two independent tubes (not shown) are utilized—one tube to provide the Phaser stream (heated, pressurized and pulsed), and another tube to provide the aspiration (vacuum). The distal end of these tubes may be straight, or may be shaped into any of the shaped depicted in FIG. 2 or into other shapes (e.g., straight, curved, or bent).

The distal portion of these tubes are inserted into the tooth in an alternating sequence through the opening in the crown (made, e.g., by the conventional techniques discussed above in the background section). First, the Phaser tube (i.e., the fluid delivery tube) in used to expose the pulp to the Phaser stream and cause it to be liquefied. Then the aspiration tube (i.e., the suction tube) is inserted to remove the liquefied pulp material. This Phaser/aspiration alternating sequence is continued until the entire chamber and canals have been cleaned. In this embodiment, the following dimensions are suitable for the Phaser stream tube: an OD (outer diameter) between 0.004-0.080 inch, an ID (inner diameter) between 0.002-0.070 inch, and a wall thickness between 0.001-0.010 inch. The following dimensions are suitable for the aspiration tube: an OD between 0.010-0.080 inch, an ID between 0.008-0.070 inch, and a wall thickness between 0.001-0.010 inch. Optionally, the distal portion of the Phaser tube and/or the aspiration tube may be tapered down to a smaller diameter at the distal tip.

FIG. 3 depicts a second embodiment, in which the Phaser stream tube 75 is fixed in position inside a larger tube 72 that provides continuous aspiration. In FIG. 3, the uppermost portion is the proximal end view, this center portion is the side view, and the bottom portion is the distal end view. In this design only one instrument is needed to simultaneously expose the pulp to both the pulsed Phaser stream and continuous aspiration. Suitable dimensions for this embodiment are as follows: for the Phaser stream tube, an OD between 0.004-0.020 inch, an ID between 0.002-0.018 inch, and a wall thickness of 0.001-0.005 inch; for the Aspiration Tube, an OD between 0.010-0.080 inch, and ID between 0.008-0.070 inch, and a wall thickness of 0.001-0.010 inch. There is preferably a taper at the distal end of the aspiration tube 72. The length of the tapered section 72d is preferably between 0.040-0.300 inch, and it tapers down to an OD of 0.010-0.060 inch and an ID of 0.008-0.050 inch at the distal end of the taper. The same wall range of thicknesses may be used in the tapered section 72d as in the straight portion of the aspiration tube 72. One example of a suitable set of dimensions within these ranges is a Phaser stream tube 75 with an OD of 0.009 inch, an ID of 0.004 inch, and a wall thickness of 0.0025 inch; and an aspiration tube 72 with an OD of 0.039 inch, an ID of 0.034 inch, and a wall thickness of 0.004 inch. The end of the aspiration tube 72 has a tapered section 72d that is 0.1 inch long, and tapers down to an OD of 0.012 inch.

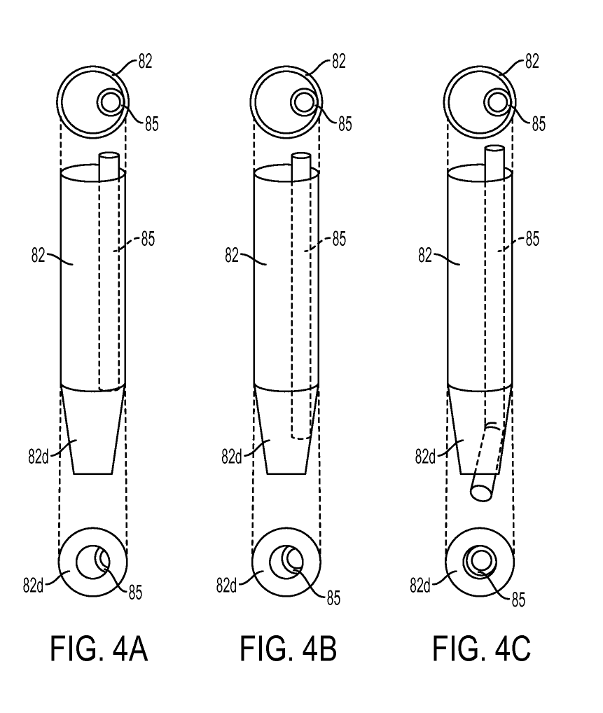

FIGS. 4A-4C depict a third embodiment, in which the Phaser stream tube 85 is also positioned inside a larger tube 82 that provides continuous aspiration. In these figures, the uppermost portion is the proximal end view, this center portion is the side view, and the bottom portion is the distal end view. Like the second embodiment, this design only requires one instrument to simultaneously expose the pulp to both the pulsed Phaser stream and continuous aspiration, and the dimensions for the Phaser tube and the aspiration tube for this embodiment are similar to the corresponding dimensions for the embodiment described above in connection with FIG. 3. However, in this embodiment, the Phaser stream tube 85 is not fixed with respect to the aspiration tube 82, and can be extended distally beyond the tip of the aspiration tube to allow further penetration into the canal if needed. This configuration is useful for penetrating into particularly narrow root canals.

In this third embodiment, the Phaser stream tube 85 is slidably mounted with respect to the aspiration tube 82. This may be accomplished by including a conduit (not shown) that runs the length of the straight portion of the aspiration tube 82. The ID of the conduit should be large enough to permit the Phaser stream tube 85 to slide within the conduit. In alternative embodiments, instead of a continuous conduit that runs the whole length of the straight portion of the aspiration tube 82, guide rings may be mounted at suitable intervals along the length of the straight portion of the aspiration tube 82 to provide a similar guiding function. FIG. 4A shows this embodiment with the Phaser stream tube 85 fully retracted, so that the distal tip of Phaser stream tube is proximal to the distal tip of the aspiration tube; FIG. 4B shows this embodiment with the Phaser stream tube 85 in a middle position; and FIG. 4C shows this embodiment with the distal tip of Phaser stream tube 85 fully extended so that it is distal to the distal tip of the aspiration tube 82. A suitable maximum extension distance of the Phaser stream tube 85 beyond the end of the tapered section 82d of the aspiration tube 82 is on the order of 0.25 inch.

A wide variety of mechanisms may be used for extending and retracting the Phaser stream tube 85 with respect to the aspiration tube 82. For example, a rack and pinion mechanism (not shown) may be used by attaching a rack to a section of the Phaser stream tube 85 that passes through the user's hand when the instrument is being used, with a pinion engaged to the rack. A manual thumbwheel or lever may then be used to rotate the pinion, which in turn advances or retracts the rack and the Phaser stream tube 85 that is attached thereto. Alternatively, an actuator (e.g., a small motor) that is controlled by a suitable user interface (e.g., a center-off rocker switch or a pair of pushbuttons) may be used to rotate the pinion to advance or retract the Phaser stream tube 85. A wide variety of alternative approaches may be readily envisioned.

In the embodiments describe above in connection with FIGS. 3 and 4, the system may be configured to perform continuous aspiration, but only generate the pulsed Phaser stream when the operator actuates a control (e.g., presses a button or a foot switch). Alternatively, the system may be configured so that the aspiration and the pulsed Phaser stream are both switched on and off together by the operator. As yet another alternative, the system may be configured so that the aspiration and the pulsed Phaser stream can be controlled independently by the operator.

The tubing material for all the tip configurations described above can be made of medical grade stainless steel, Nitinol, or other medical grade metallic tubes. Alternatively, the tubes can also be made from polymeric material that can withstand temperatures above 100° F. and 300 psi such as PEEK, Teflon, and other polymer materials.

It is envisioned that the above-describe embodiments will be used to completely replace step 2 of the conventional root canal procedure described in the background section above, to implement both the initial stages of pulp removal (i.e., removing the pulp in the central pulp chamber of the tooth) and the subsequent stages in the narrower portions of the root (i.e., by directing the tip of the Phaser System into each individual root canal). However, the devices they may also be used to augment step 2 of a conventional root canal procedure. For example, the initial stages of pulp removal may be implemented mechanically using conventional mechanical techniques, and the Phaser device may be used only for subsequent stages in the narrower portion of the root, until substantially all of the pulp has been removed. The decision of whether to use only one technique or to combine both conventional and Phaser-based pulp removal may be left to the individual dentist, depending on the circumstances.

After the pulp has been removed from each of the roots, the temperature of the fluid that is injected into the tooth can be increased to above 160° F. to flush and clean the canal of bacteria.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. An apparatus for removing pulp from a tooth with an opening therein, the apparatus comprising:
a suction tube having (a) an input port located at a distal tip of the suction tube and (b) an output port, wherein the distal tip of the suction tube is configured for insertion into the tooth through the opening in the tooth;
a suction source configured to generate a negative pressure within the suction tube to draw liquids into the suction tube via the input port of the suction tube;
a delivery tube having (a) an output port located at a distal tip of the delivery tube and (b) an input port, wherein the distal tip of the delivery tube is disposed within the suction tube, and the distal tip of the delivery tube is fixed in position with respect to the distal tip of the suction tube;
a temperature control system configured to bring a fluid to a temperature between 140° F. and 200° F.; and
a pump configured to pump the temperature-controlled fluid through the delivery tube so that the temperature-controlled fluid exits the output port in pulses at a pressure between 300 and 3000 psi,
wherein the delivery tube and the suction tube are configured so that fluid exiting the output port of the delivery tube will impinge against the pulp, and that material in the tooth is drawn into the input port of the suction tube by the suction source.

2. The apparatus of claim 1, wherein the temperature control is configured to bring the fluid to a temperature of about 160° F.

3. The apparatus of claim 1, wherein the pump is configured to pump the temperature-controlled fluid through the delivery tube so that the temperature-controlled fluid exits the output port in pulses at a pressure between 300 and 1300 psi.

4. The apparatus of claim 1, wherein the pump generates the pulses at a rate between 10 and 60 pulses per second.

5. An apparatus for removing pulp from a tooth with an opening therein, the apparatus comprising:
a suction tube having (a) an input port located at a distal tip of the suction tube and (b) an output port, wherein the distal tip of the suction tube is configured for insertion into the tooth through the opening in the tooth;
a suction source configured to generate a negative pressure within the suction tube to draw liquids into the suction tube via the input port of the suction tube;
a delivery tube having (a) an output port located at a distal tip of the delivery tube and (b) an input port, wherein at least a portion of the delivery tube is disposed within the suction tube, and at least a distal portion of the delivery tube is movable with respect to the suction tube between (a) a first position in which the distal tip of the delivery tube is proximal to the distal tip of the suction tube and is within the suction tube and (b) a second position in which the distal tip of the delivery tube is distal to the distal tip of the suction tube;
a temperature control system configured to bring a fluid to a temperature between 140° F. and 200° F.; and
a pump configured to pump the temperature-controlled fluid through the delivery tube so that the temperature-controlled fluid exits the output port in pulses at a pressure between 300 and 3000 psi,
wherein the delivery tube and the suction tube are configured so that fluid exiting the output port of the delivery tube will impinge against the pulp, and that material in the tooth is drawn into the input port of the suction tube by the suction source.

6. The apparatus of claim 5, wherein the temperature control is configured to bring the fluid to a temperature of about 160° F.

7. The apparatus of claim 5, wherein the pump is configured to pump the temperature-controlled fluid through the delivery tube so that the temperature-controlled fluid exits the output port in pulses at a pressure between 300 and 1300 psi.

8. The apparatus of claim 5, wherein the pump generates the pulses at a rate between 10 and 60 pulses per second.

9. A method of removing pulp from a tooth with an opening therein, the method comprising the steps of:
delivering fluid, via a first conduit, so that the fluid exits the first conduit and impinges against the pulp, wherein the fluid is delivered in pulses at a temperature between 140° F. and 200° F. and at a pressure between 300 and 1300 psi;
suctioning away, via a second conduit, pulp that has been softened, liquefied, or gellified by the fluid in the delivering step; and
repeating the delivering and suctioning steps until substantially all the pulp has been removed from the tooth.

10. The method of claim 9, wherein the fluid is delivered at a temperature of about 160° F.

11. The method of claim 9, wherein the fluid is initially delivered at a temperature of about 140° F., and further comprising the step of delivering fluid, via the first conduit, to the interior of the tooth from which substantially all the pulp has been removed at a temperature of between 160° F. and 200° F. for enough time to kill harmful microorganisms that may be present within the tooth.

12. The method of claim 9, wherein the fluid is initially delivered at a temperature of about 140° F., and further comprising the step of delivering fluid, via the first conduit, to the interior of the tooth from which substantially all the pulp has been removed at a temperature of about 160° F.

13. The method of claim 9, wherein the fluid is delivered at a pressure between 1000 and 1300 psi.

14. The method of claim 9, wherein the fluid is delivered at a pulse rate between 10 and 60 pulses per second.

15. The method of claim 9, wherein the fluid is delivered at a pulse rate between 20 and 40 pulses per second.

16. The method of claim 9, wherein the delivering and suctioning steps are performed in an alternating sequence.

17. The method of claim 9, wherein the delivering and suctioning steps are performed simultaneously.

18. The method of claim 9, wherein the suctioning step comprises suctioning with a vacuum between 300 and 760 mm Hg.
